(19) United States
(12) Patent Application Publication
(10) Pub. No.: US 2008/0021798 A1
(43) Pub. Date: Jan. 24, 2008

(54) Method For Providing Any Type Of Storage Media Containing Prerecorded Structured Information

(75) Inventors: Birte Achten, Koln (DE); Frank Augustin, Langenfeld (DE); Oliver Gebert, Koln (DE); Stephan Kohl, Leverkusen (DE); Christoph Schaub, Koln (DE); Michael Schimeczek, Leverkusen (DE); Achim Zielesny, Dusseldorf (DE)

Correspondence Address: NORRIS, MCLAUGHLIN & MARCUS, 875 THIRD AVE, 18TH FLOOR, NEW YORK, NY, 10022, US

(73) Assignee: Bayer Business Services GMBH, Leverkusen (DE)

(21) Appl. No.: 10/591,220

(22) PCT Filed: Feb. 19, 2005
(86) PCT No.: PCT/EP05/01748

§ 371 Date: Oct. 11, 2006

(30) Foreign Application Priority Data
Mar. 4, 2004 (DE) 102004010517.0
Jul. 2, 2004 (DE) 102004032231.7

(51) Int. Cl. G06F 17/00

(52) U.S. Cl. 705/30

(57) ABSTRACT

A method for producing storage media containing prerecorded structured information, which contains an order management and tracking system accessible via the Intranet/Internet, the conversion and/or selective extraction of searched structured information from different data sources into a universal data model, wherein the correlation of the information with the corresponding matching order from the order management and tracking system, and the provision of the storage media of any type, containing prerecorded structured information with unified format.

### BACKGROUND OF THE INVENTION

The present application comprises a method for providing any type of storage media containing prerecorded structured information.

A high demand for information which is edited in a structured, and therefore easily processable way, exists in the most varied fields of activity, particularly in research but also in the legal profession and other professions and fields of responsibility relying on the processing of information in order to be able to perform the work sequences rapidly and efficiently. In addition, they should be easy to obtain and available rapidly and everywhere, if possible.

This processing of information is traditionally the job of staff members who procure and edit the information manually.

Since the development of electronic aids, a multiplicity of methods has been produced which is intended to support and accelerate this work.

From the prior art, various systems for procuring information, for document management and for the analysis of technical literature and patents are known.

Information can be procured in various manners:

From JP 10031684 A, JP 08272818 A, JP2002073606 A and WO 03/098469 A, methods and systems for the automated search for information in patent and literature databases are known.

In KR 2001107797 A and JP 2002163275 A, the documents obtained are automatically classified in addition to the automated search and in JP 2001337991 A and U.S. Pat. No. 5,752,020 A, an automatic similarity check and a doublet matching method are also described. All these methods have in common that they dispense with the know-how and experience of an information broker during the search and do not provide any intellectual tidying and editing of the search results obtained.

From KR 2001107797 A alone, a method for commenting on documents by a patent specialist is known, commenting being only one aspect of information editing.

As shown by experience, including information brokers in the procurement and subsequent editing of information is of great use, however.

Issuing the order and tracking the order during the search to be performed iteratively and in consultation with the client can again be supported by electronic aids.

The advantages of automated documentation and communication (e-mail notification) of order management and tracking systems are known from US 2003135403 A and US 2003144916 A.

US 2003050852 A and WO 02/25545 A describe the possibility of tracking the changing status of the orders and information. From WO 01/97100 A, for example, the utilization of the Internet for issuing orders is known.

Workflows for applying for patents and trademarks (WO 01/97100 A, WO 01/86522 A, for matching documents in the national phase with their PCT applications (WO 02/37344 A) and for IP management generally (US 2001037460 A, US 2001039505 A, WO 200159679 A) are also known.

The work sequences and specifics of the professional search by an information broker have hitherto not been described by any known system and method.

Editing the documents obtained by the professional search and/or other information, e.g. research by a customer in end user sources, is another aspect:

From U.S. Pat. No. 5,991,751 B, a system is known which is based on patent databases and other databases with information which is of interest to a company. In this system, various groups are formed, each one of the groups containing a number of patents of the patent database. Following a corresponding command, the patents belonging to one of the groups are processed in conjunction with the information of the further databases. It is also possible to automatically find, for example, patent citations, the number of patents by an inventor, and the like.

From U.S. Pat. No. 5,721,910 B, a relational database is known which contains a multidimensional hierarchical model of categories related to one another. This database can be used for determining the significance contained in scientific or technical documents such as, for example, patents or abstracts of these patents and allocating the documents to a particular scientific or technical category in the multidimensional hierarchical model.

From U.S. Pat. No. 6,038,561 B, a system for the management and the analysis of documents is known. The system is interactive and allows both a word-based analysis and a conceptual analysis and the display of information. A particular field of application is the analysis of patent literature such as, for example, patent claims.

From WO 00/52618 A, a system for the so-called Intellectual Property Asset Management is known. In this system, data from various databases are brought together and quotations and inventor details are evaluated.

From U.S. Pat. No. 5,999,907 B, a checking system for intellectual property is known which is used for evaluating a portfolio. The system contains a database which contains information relating to a portfolio of industrial protective rights. The system contains other databases for storing empirical data for evaluating the portfolios. In this system, qualitative characteristic numbers are determined which are calibrated on the basis of economic values.

From U.S. Pat. No. 6,014,663 B, a system for analyzing a document is known which verifies the consistent use of terminology in a patent application.

From U.S. Pat. No. 5,991,780 B, a system for selectively displaying patent texts and drawings is known. The text and the drawings are stored in separate files and represented together on a user interface.

From U.S. Pat. No. 5,950,214 B, WO 00/11575 A and U.S. Pat. No. 6,018,749 B, other systems for processing and displaying patent documents are known.

Methods for patent analysis are also known from the European patent application number 001 18 457 and from Brockhoff K K: “Indicators of Firm Patent Activities”, Portland, Oct. 27-31, 1991, New York, IEEE, US, vol. October 1991 (1991-10), pages 476-481, XP002923550, and Stefanov V: “Some Possibilities of a Patents Database in Determining a Firm's Policy”, World Patent Information, GB, Elsevier Sciences Publishing, Barking, vol. 17, No. 3, 1 Sep. 1995 (1995-09-01), pages 201-204, XP004037786, ISSN: 0172-2190.

All these known systems have the disadvantage that they deal in each case with part-aspects such as the analysis of data or the search for data and in most cases are only directed to patent documents as data sources. Other information sources such as publications in journals, structured information created internally in a company in the form of reports etc. are not integrated in the known systems, or only incompletely so. Correspondingly, it is not provided to bring together documents from different sources of professional search with documents from different end user sources or internal sources, and no analysis and processing functionalities are provided which can process the documents jointly.

These methods do not deal with the problems of order management or even of tracking by the user or client in the field of information procurement, at all.

### SUMMARY OF THE INVENTION

On the basis of the prior art, the invention is, therefore, based on the object of providing a method for computer-supported information management, provision and analysis for structured information, which supports the work sequences between information procurement and end user and guarantees uniform finishing, structuring and administration of information from different sources independently of their origin and type, and allows group work. The method is intended to contain efficient order management and tracking. In particular, it is intended to allow structured information to be utilized efficiently and thus to increase the quality and efficiency of the work.

This object is achieved by the method according to the invention. In this context, it was particularly surprising that, by combining various known concepts and by using a universal data model, a solution has been produced which provides much simpler operation and higher efficiency of the work for the user.

Such a method has now been found surprisingly. The present invention comprises a method, containing:
1. an order management and tracking system accessible via the Intranet/Internet, preferably for search departments and information brokers, which, in a particularly preferred manner, maps the corresponding work sequences (e.g. iterative literature and patent searches, maintenance of customer-related databases) and enables the performing functions, preferably persons and/or electronic systems, to perform order administration, order processing, in particular professional search and editing/analysis of the information obtained, documentation and accounting, preferably in an SAP-compatible data format and guarantees for the customer, preferably a single customer and/or a group of customers, the delivery of orders, status control, cost control, reception of e-mail notification about order processing/result adjustment;
2. the conversion and/or selective extraction and combining of the structured information, searched by professionals such as information brokers and/or customers, from different data sources by information broker and/or customer into a universal data model consisting of “data pool—document—descriptor—content”;
3. the correlation of the information with the corresponding matching order from the order management and tracking system, tagging/commenting is also possible in preferred manner;
4. the provision of the structured information with unified format on any type of storage media, preferably in a central database accessible via the Intranet/Internet, for example as virtual personalized individual-customer/customer-group database or in a file format on any type of fixed or transportable storage media, in a particularly preferred manner on a central database accessible via the Intranet/Internet, wherein, by means of the provision, preferably also

the subsequent processing, defined in the functionality, of the structured information in database or file is made possible by visual display, sorting, searching, analyzing, commenting, organizing (deleting, storing, grouping, marking of data/data pools), importing of structured data, exporting, appending of documents, access to Intranet/Internet services with additional information (e.g. ordering services, display of originals, . . . ), wherein this functionality can be controlled via a license key system depending on authorization of the user;

and/or

the subsequent further analysis of the data by data mining functions is made possible, among other things, for one- and multi-dimensional descriptor analyses (histograms, 2-D frequency matrices), automated cluster and similarity analyses on the basis of descriptor-based fingerprint vectors, multi-trunked Boolean full-text searches, comparison of biological sequences, structure/substructure/similarity analyses in the case of chemical structures and reactions.

Data contents which can be processed, acquired and made available in structured form by the method according to the invention can be: information in structured form, e.g. descriptor—content, text and graphics, from the field of:
chemistry, e.g. also structures, reactions, spectra,
biochemistry, life sciences, particularly also DNS/protein/peptide/biopolymer sequences (also carbohydrates),
toxicology, particularly eco-toxicology,
polymer chemistry,
physics, preferably from the fields of material properties/material testing/analytics,
engineering such as process technology, plant construction, process parameters, parameter control

but also from the fields of
economics such as market studies, production and consumption, economic news,
law such as case law or international laws.

Data sources which are used in the method according to the invention can be both professional and end-user sources:
databases of various hosts, for example STN, Dialog, Datastar, DIMDI, Questel, FIZ Technik, etc., or
individual databases with their own formats, for example Scifinder, Micropatent, etc.,
public biological databases such as GenBank, SwissProt, PDB, etc.,
databases with in-house company information such as e.g. research reports, visit reports, technical reports and many others.

In this context, the information from the data sources can be searched by both information brokers and end customers.

Suitable functionalities, which can be available, for example, in the form of corresponding programs/program modules, for processing of structured information both by the end user and by the information broker in the context of the method according to the invention, are, for example:
importation of structured data,
exportation of data in different formats (text, tables, . . . ),
appending documents,
visual display of the information as individual document with/without graphics and tables as set of documents in table format, in matrix format, in histogram format, etc.,
direct access to Intranet/Internet services with supplementary information which is directly related to the information (e.g. original patents, document ordering services),
sorting in accordance with alphanumeric principles, including trunking,
text searches in various modes: e.g. “Easy”—individual terms by using trunking, “Advanced”—with the aid of Boolean operators in descriptor fields to be selected, “Expert”—with the aid of regular expressions and list logic in descriptor fields to be selected, etc.—representation of the search results in histogram form, correlation with the corresponding documents,
chemical structure searches in various modes: exact structure, substructure, similarity search, correlation with the corresponding documents,
biological sequence searches: local or global alignment search for DNS/protein/peptide/biopolymer sequences (also carbohydrates), correlation with the corresponding documents,
searching similar documents by using coding classifications (IPC, MC, DC, etc.) and/or search term frequencies with the aid of neural networks, indicating priority lists of search results in histogram form, correlation with the corresponding documents, adaptation of evaluation parameters for creating priority lists. Data mining functions for, among other things, one- and multi-dimensional descriptor analyses: analyzing for arbitrary descriptors to be selected, one-dimensionally in histogram view (sortable), multi-stage analysis possible, two-dimensionally in matrix form, correlation with the corresponding documents. Automated cluster and similarity analyses on the basis of descriptor-based fingerprint vectors,
commenting on individual documents and/or sets of documents in accordance with the principle of “descriptor-content” by using individual conceptualities (individual customer)/controlled vocabulary (customer groups),
automatic “descriptor-content”—generation/commenting on the basis of search results or criteria to be defined,
converting coding classification into plain text,
organizing (deleting, storing, marking, grouping).

Apart from databases, the storage media used can also be any types of fixed and/or transportable storage media such as hard disks (data transfer by ftp), floppy disks, CD-ROM, DVD-ROM, Blue-ray disk, Flash Disks (USB sticks) etc.

Together with the result document stored thereon and preferably a reading or viewing program, also stored thereon, for representing the result document, these storage media represent the technical end product of the method according to the invention. This end product is also the subject matter of the present application.

A corresponding computer program for supporting the present method and the basic concept as shown by way of example but not exclusively in the following workflows is also the subject matter of the present application.

### BRIEF DESCRIPTION OF THE DRAWINGS

FIG. 1 Shows a flow chart for a method providing any type of storage media with prerecorded structured information.

FIG. 2 Shows a flow chart for the order management and tracking system.

FIG. 3 Shows a flow chart of information management and analysis system.

### DETAILED DESCRIPTION OF THE DRAWINGS

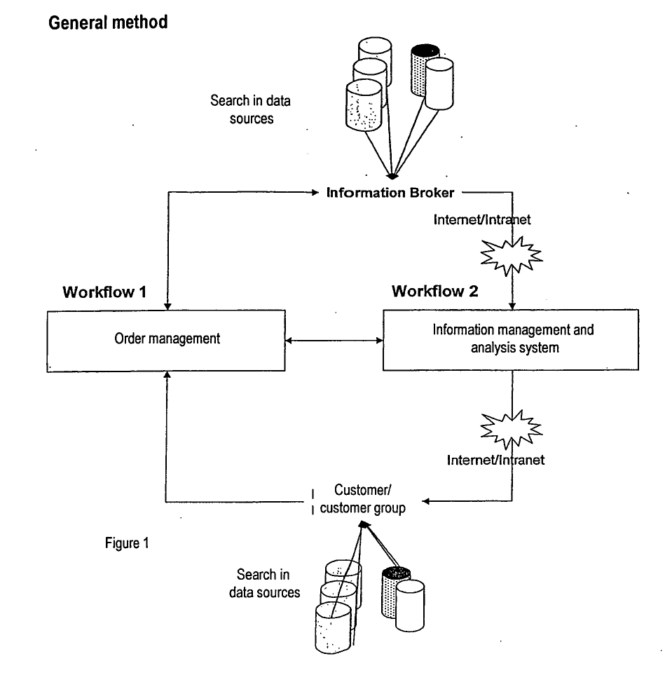

The method for providing any type of storage media containing prerecorded structured information can be described in two part-workflows (FIG. 1):
1. The workflow of the order management and 2. the workflow of the information management and analysis system.

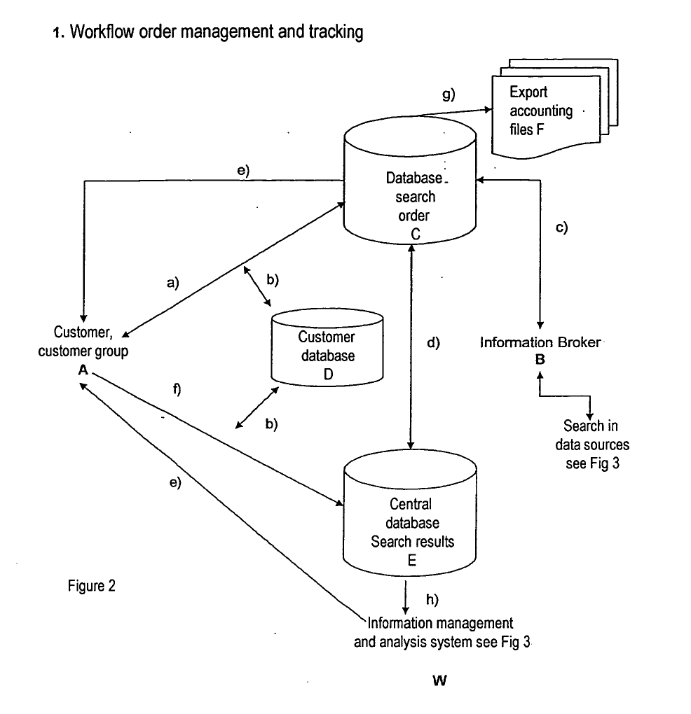

Workflow of the order management and tracking system (FIG. 2):

An individual customer or a customer as representative of a customer group (A) issues a search order via an electronic form (a)) available on the Intranet/Internet, by entering his customer data (b)). Conceivable orders are singular orders relating to a particular subject or continuing literature and patent tracking, e.g. for observing the competition.

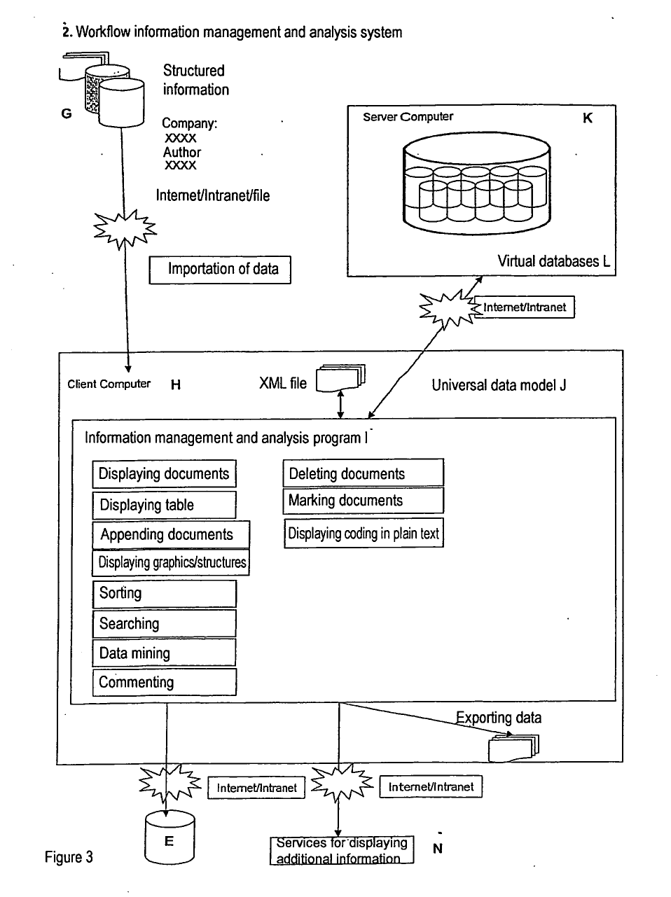

The order is entered into the order database (C), is assigned (c)) to a searcher (B) and processed. Customer (A) and searcher/information broker (B) receive an e-mail notification about the process (a)) and (c)). If information in the sense of the order is found, a part of the documentation is completed (c)) by the information broker (B) in the order form and, in correlation with the original order, a result document with explanatory data relating to the result (metadata) is generated (d)) in the result database (E) and the result data are stored (h)) in the information management and analysis system (workflow 2, FIG. 3) and processed and reassessed with the aid of the functionalities available there, and the results data can also be stored optionally in the result database (E). The customer (A) is sent a hyperlink to the result document in the result database (E) by e-mail (e)), via which he receives access to the result data in the information management and analysis system (workflow 2, FIG. 3). When calling up the link (f), the customer/the customer group (A) must authenticate himself/themselves (b)) to the customer database (D) or another authentication service (e.g. LDAP).

The customer (A) can also obtain information proactively about his orders on the Intranet/Internet (a)) after authentication (b)). Information about the status, the information broker dealing with the order, the costs accruing, etc. are provided as an overview.

Other functionalities for the administration and processing of orders are utilized by the search department/information broker (B) such as e.g. the above-mentioned documentation of the orders, the exporting of data (g)) for statistical evaluation, the outputting of data (g)) for the accounting of orders in SAP-compatible formats (F).

Workflow of the information management and analysis system (FIG. 3)

Structured data (G) from different sources are imported into the universal data model (J) by information brokers or the end user with the aid of the information management and analysis program (I) via the Intranet/Internet or as a file on the client computer (H), the data model is available in an XML file (optionally compressed) in the file system of the client computer and is (optionally) linked to the database of the server computer (K) via a replication mechanism. The server computer can be connected to the client (H) via the Internet/Intranet. There are virtual databases (L) for various users or user groups in the database (K) which permit both the protection of personal data and group work. The structured data can be loaded from the universal data model (J) into the client program (I) in order to be processed there with the aid of the different functionalities. Changes and additions can be stored in the universal data model (J). Data can be exported as files of different formats on the client (H). The data can be correlated with a search order by accessing the correspondingly linked result document in the result database (E) (see workflow 1). Ongoing information can be obtained by the program (I) accessing services on the Internet and Intranet.

What is claimed is:

1. A method for producing storage media containing prerecorded structured information, comprising the steps of
providing an order management and tracking system accessible via the Intranet/Internet,
providing conversion and/or selective extraction of searched structured information from different data sources into a universal data model, wherein the correlation of the information with the corresponding matching order from the order management and tracking system, and the provision of the storage media of any type, contain prerecorded structured information with unified format.

2. The method as claimed in claim 1, wherein the order management and tracking system maps the workflows of a search department or of an information broker and enables the performing functions to perform order management, order processing, documentation and accounting.

3. The method as claimed in claim 2, wherein the method provides for accounting by data transmission in SAP-compatible format.

4. The method as claimed in claim 2, wherein the order processing includes professional search and information editing.

5. The method as claimed in claim 2, wherein the information editing is an integral component of the order processing by utilizing analysis functionalities by information brokers.

6. The method as claimed in claim 5, wherein, as part of the information editing, unified structured information from professional and/or end user sources is imported, assembled and jointly analyzed by information brokers and/or customers.
